(19) United States
(12) Patent Application Publication
(10) Pub. No.: US 2023/0012171 A1
(43) Pub. Date: Jan. 12, 2023

(54) PROPELLANT INJECTOR FOR HYBRID ROCKET ENGINES

(71) Applicant: AT SPACE PTY LTD, North Adelaide (AU)

(72) Inventor: Yen-Sen CHEN, North Adelaide (AU)

(21) Appl. No.: 17/367,627

(22) Filed: Jul. 6, 2021

(51) Int. Cl. F02K 9/52; F02K 9/72

(52) U.S. Cl. CPC F02K 9/52; F02K 9/72; F02K 9/48

(57) ABSTRACT

A propellant injector is adapted to be installed to a hybrid rocket engine and includes an injector casing, a tube and a plurality of blades. The tube is arranged along a center axis of the propellant injector in an inner space of the injector casing. The plurality of blades is disposed to and evenly distributed over an outer surface of the tube, and is configured to cause vortices toward a combustion chamber of the hybrid rocket engine when being driven to rotate.

### BACKGROUND

### Field of the Invention

The present invention relates to an injector, and more particularly to a propellant injector for hybrid rocket engines.

### Description of Related Art

Typically, aerospace propulsion systems, i.e., rocket engines, are provided with propellant injectors for injecting propellant into their combustion chamber. Conventional propellant injector designs are sorted into many injector types such as showerhead, impingers, coaxial, swirl, co-swirl, counter-swirl, pintle types, etc. In the case of hybrid rockets, the combustion chamber usually has a long cylindrical block of solid grain and one or more combustion channels (or ports) therein. If the propellant flow injected into the combustion chamber by the propellant injector can be well spread along the entire combustion channel(s) of the combustion chamber, the injected propellant can be mixed with the solid grain well in the combustion chamber such that efficient combustion can be achieved for good propulsion performance. Although swirl injectors can provide good mixing effects along the length of the ports, swirl injectors will cause torques on the longitudinal axis of the rocket system, leading to undesirable spins of the rocket system, especially undesirable spins of the launch vehicle.

### SUMMARY

One objective of the present invention is to provide a propellant injector for replacing conventional injectors.

Another objective of the present invention is to provide a propellant injector capable of avoiding the generation of torques on the longitudinal axis of the rocket system that causes undesirable spins of the rocket system, especially to launch vehicles.

Yet another objective of the present invention is to provide a propellant injector capable of providing vortices for enhancing the mixing effect of propellant injected into the combustion chamber of the hybrid rocket engine.

To achieve the foregoing and other objectives, the present invention provides a propellant injector according to an embodiment, and the propellant injector is adapted to be installed to a hybrid rocket engine and includes an injector casing, a tube and a plurality of blades. The tube is arranged along a center axis of the propellant injector in an inner space of the injector casing. The plurality of blades is disposed to and evenly distributed over an outer surface of the tube, and is configured to cause vortices toward a combustion chamber of the hybrid rocket engine when being driven to rotate.

In another embodiment of the propellant injector, a first angle of attack between a first blade of the plurality of blades and the center axis of the propellant injector is represented by al, and the propellant injector satisfies the following condition: 5<|α1|<30. Furthermore, in yet another embodiment of the propellant injector, a second angle of attack between a second blade of the plurality of blades and the center axis of the propellant injector is represented by α2, the first blade is adjacent to the second blade, and the propellant injector further satisfies the following condition: −α1=α2.

In yet another embodiment of the propellant injector, a first angle of attack between a first blade of the plurality of blades and the center axis of the propellant injector is represented by α1, a second angle of attack between a second blade of the plurality of blades and the center axis of the propellant injector is represented by α2, the first blade is adjacent to the second blade, and the propellant injector satisfies the following condition: −α1=α2.

In yet another embodiment of the propellant injector, a radius of the tube is represented by R1, a radial distance between a center axis of the tube and an edge of the blade far from the outer surface of the tube is represented by R2, a radial distance between the center axis of the tube and an inner surface of the injector casing is represented by R3, and the propellant injector satisfies the following condition: R1<R2<R3.

In yet another embodiment of the propellant injector, a chord length of the blade is represented by Cb, a radial height of the blade with respect to the outer surface of the tube is represented by D, and the propellant injector satisfies the following condition: 0.5 D<Cb<5 D.

In yet another embodiment of the propellant injector, an amount of the plurality of blades is even.

In yet another embodiment of the propellant injector, the plurality of blades is located at an outlet of the propellant injector.

In yet another embodiment of the propellant injector, adjacent two of the plurality of blades adjoin each other. Alternatively, adjacent two of the plurality of blades are spaced a distance apart from each other in yet another embodiment of the propellant injector.

In yet another embodiment of the propellant injector, at least a part of the tube and the plurality of blades are integrated in one piece.

In yet another embodiment of the propellant injector, the blade is a plate shape or airfoil shape.

In yet another embodiment of the propellant injector, the blade comprises two opposite edges respectively facing an inlet and outlet of the propellant injector, and at least one of the two edges is inclined with respect to the outer surface of the tube.

### BRIEF DESCRIPTION OF THE DRAWINGS

After studying the detailed description in conjunction with the following drawings, other aspects and advantages of the present invention will be discovered:

FIG. 1 is a side view of a propellant injector according to an embodiment of the present invention; and

FIG. 2 is another side view of a propellant injector according to an embodiment of the present invention.

### DETAILED DESCRIPTION

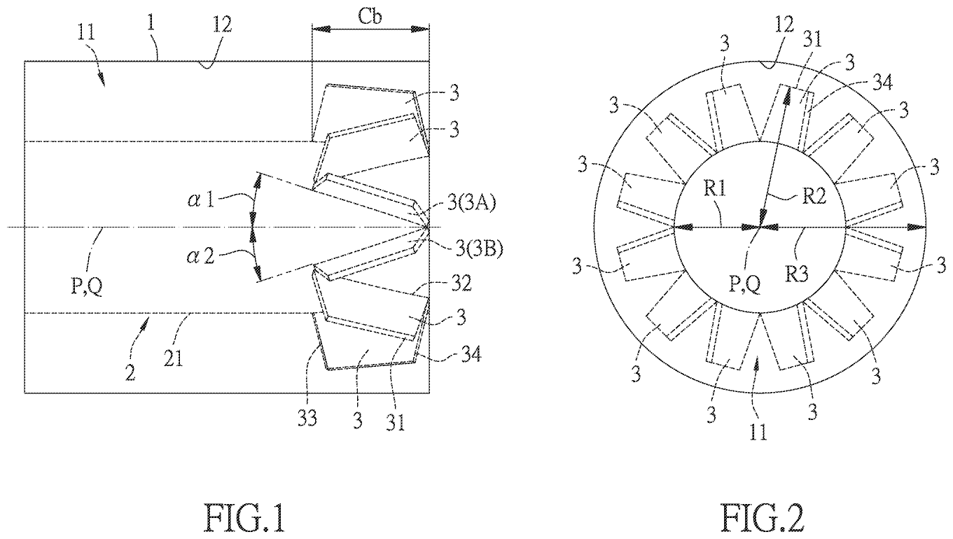

Please refer to FIGS. 1 and 2, illustrating a propellant injector according to an embodiment of the present invention. The propellant injector is a vortex-based injector and is adapted to be installed to a hybrid rocket engine. The outlet of the propellant injector is oriented to, for example, but not limited to, a combustion chamber of the hybrid rocket engine so that the propellant flow passing through the propellant injector can be pushed to the combustion chamber of the hybrid rocket engine, especially the combustion channel(s) in the combustion chamber, by vortices caused by the propellant injector.

The propellant injector includes an injector casing 1, a tube 2 and a plurality of blades 3. The tube 2 is installed in an inner space 11 of the injector casing 1, and has a center axis Q parallel to a center axis P of the propellant injector. For instance, the center axis Q of the center axis P of the propellant injector fully overlap each other, as shown in FIG. 1. All the blades 3 are disposed to the outer surface 21 of the tube 2 and evenly distributed over the outer surface 21.

In this embodiment, the blades 3 are arranged at the outlet of the propellant injector, as shown in FIG. 1. Therefore, the propellant flow passing through the tube 2 from the inlet of the propellant injector (e.g., the left side of the drawing) to the outlet of the propellant injector (e.g., the right side of the drawing) can be pushed out in the vortices caused by the rotating blades 3. However, the present invention is not limited to this embodiment. In other embodiments, the blades 3 may be arranged at the inlet or middle of the propellant injector.

Each blade 3 is, for example, but not limited to, a plate shape or airfoil shape. Each blade 3 includes an edge 31 contacting the outer surface 21 of the tube 2, an edge 32 opposite to the edge 31 and far from the outer surface 21, and two opposite edges 33 and 34 respectively facing the inlet and outlet of the propellant injector, as shown in FIG. 1. At least one of the two edges 33 and 34 is inclined with respect to the outer surface 21 of the tube 2. In this embodiment, both the two edges 33 and 34 are inclined with respect to the outer surface 21 of the tube 2.

The blades 3 disposed on the tube 2 can be oriented in different directions. To clarify the arrangement of the blades 3 on the tube 2, two adjacent blades 3 are defined as a first blade 3A and a second blade 3B, as shown in FIG. 1. The first blade 3A and the center axis P of the propellant injector have a first angle of attack α1 therebetween, and the second blade 3B and the center axis P of the propellant injector have a second angle of attack α2 therebetween. The propellant injector satisfies the condition (1): −α1=α2. Preferably, the propellant injector further satisfies the following conditions (2): 5<|α1|<30. Through such an arrangement, torques in the longitudinal axis parallel to the center axis P of the propellant injector is possibly avoided, resulting in the prevention or decreasing of spinning of the rocket system.

Moreover, the propellant injector further satisfies the following conditions (3) and (4):

R1<R2<R3 (3), and

0.5 D<Cb<5 D (4),

wherein R1 represents a radius of the tube 2, R2 represents a radial distance between the center axis Q of the tube 2 and an edge 31 of the blade 3 opposite to an edge 32 of the blade 3, R3 represents a radial distance between the center axis Q of the tube 2 and the inner surface 12 of the injector casing 1, Cb represents a chord length of the blade 3, and D represents a radial height of the blade 3.

In this embodiment, the whole tube 2 and the blades 3 are integrated in one piece so that the tube 2 can drive the blades 3 to rotate with respect to the injector casing 1 when being driven. However, other embodiments may contemplate that a part of the tube 2 and the blades 3 are integrated in one piece so that the part of the tube 2 can drive the blades 3 to rotate with respect to the injector casing 1 as well as the other part of the tube 2 when being driven. Alternatively, other embodiments may contemplate that the tube 2 and the blades 3 are formed to two separate pieces and can be assembled together. Therefore, the blades 3 can cause vortices toward the combustion chamber of the hybrid rocket engine when rotating. Moreover, when the number of blades 3 is even, the vortices cause by the rotating blades 3 possibly get more even and stable, resulting in better mixing effect in the combustion chamber of the hybrid rocket engine.

Among all the blades 3, every two adjacent blades 3 adjoin each other, as shown in FIG. 2. That is, the two adjacent blades 3 contact each other. Alternatively, every two adjacent blades 3 may be spaced a distance apart from each other in yet another embodiment.

Through the internal disposition of the tube and the blades, the propellant injector according to the present invention can serve as a vortex-based propellant injector capable of causing vortices for efficiently injecting propellant toward the combustion chamber of the hybrid rocket engine, instead of conventional injectors such as showerhead, impinger, coaxial, swirl, co-swirl, counter-swirl, and pintle type injectors, so that the mixing effect of the injected propellant within the entire combustion channel of the combustion chamber is possibly enhanced greatly. Through the different orientations of the blades on the outer surface of the tube, the propellant injector may prevent the occurrence of torques in the longitudinal axis of the rocket system, so that the undesirable spins may not occur to the rocket system.

While we have shown and described various embodiments in accordance with the present invention, it is clear to those skilled in the art that further embodiments may be made without departing from the scope of the present invention.

1. A propellant injector, adapted to be installed to a hybrid rocket engine comprising a combustion chamber, and comprising:
an injector casing;
a tube, being drivable and arranged along a center axis of the propellant injector in an inner space of the injector casing; and
a plurality of blades, disposed to and evenly distributed over an outer surface of the tube, and configured to cause vortices toward the combustion chamber when being driven by the tube to rotate,
wherein orientations of every two adjacent blades of the plurality of blades are arranged in a mirror symmetry manner; and
an outlet of the propellant injector is oriented to the combustion chamber.

2. The propellant injector according to claim 1, wherein a first angle of attack between a first blade of the plurality of blades and the center axis of the propellant injector is represented by α1, a second angle of attack between a second blade of the plurality of blades and the center axis of the propellant injector is represented by α2, the first blade is adjacent to the second blade, and the propellant injector satisfies the following conditions: 5°<|α1|<30°; and −α1=α2.

3. (canceled)

4. (canceled)

5. The propellant injector according to claim 1, wherein a radius of the tube is represented by R1, a radial distance between a center axis of the tube and an edge of the blade far from the outer surface of the tube is represented by R2, a radial distance between the center axis of the tube and an inner surface of the injector casing is represented by R3, and the propellant injector satisfies the following condition: R1<R2<R3.

6. The propellant injector according to claim 1, wherein a chord length of the blade is represented by Cb, a radial height of the blade with respect to the outer surface of the tube is represented by D, and the propellant injector satisfies the following condition: 0.5 D<Cb<5 D.

7. The propellant injector according to claim 1, wherein an amount of the plurality of blades is even.

8. The propellant injector according to claim 1, wherein the plurality of blades is located at an outlet of the propellant injector.

9. The propellant injector according to claim 1, wherein adjacent two of the plurality of blades adjoin each other.

10. The propellant injector according to claim 1, wherein adjacent two of the plurality of blades are spaced a distance apart from each other.

11. The propellant injector according to claim 1, wherein at least a part of the tube and the plurality of blades are integrated in one piece.

12. The propellant injector according to claim 1, wherein each blade is a plate shape or airfoil shape.

13. The propellant injector according to claim 1, wherein each blade comprises two opposite edges respectively facing an inlet and outlet of the propellant injector, and at least one of the two edges is inclined with respect to the outer surface of the tube.
